(19) United States
(12) Patent Application Publication
(10) Pub. No.: US 2008/0234854 A1
(43) Pub. Date: Sep. 25, 2008

(54) ROOF AND WALL CONSTRUCTION

(76) Inventors: Graeme Keith Stark, West Wollongong (AU); Brad Ryan, Dapto (AU)

Correspondence Address: MICHAEL BEST & FRIEDRICH LLP, 100 E WISCONSIN AVENUE, Suite 3300, MILWAUKEE, WI, 53202, US

(21) Appl. No.: 11/689,780

(22) Filed: Mar. 22, 2007

(51) Int. Cl. G06F 19/00; G06F 17/50

(52) U.S. Cl. 700/148; 703/1; 29/897.3

(57) ABSTRACT

The invention relates to roll forming roofing and walling sheets that have pre-cut or pre-marked ends and packing the sheets. The invention includes applying a particular set of rules to a roll forming schedule produced by a current program, such as an Applicad Roof Wizard program, and producing a roll forming schedule that roll forms sheets in an order that does not require sorting after roll forming but results in sheets packed in a logical order for the person cladding a structure, such as a roof or a wall.

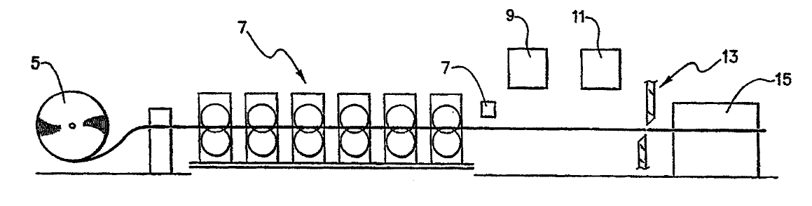

The present invention relates to cladding of building structures, particularly roofs and walls, from roll-formed metal cladding sheets.

In particular, the present invention relates to roll forming roofing and walling sheets that have pre-cut or pre-marked ends and packing the sheets in the order produced by the roll-former and forming packs of sheets that are ordered in a way that is the same as the order that a roofer requires the sheets to construct a roof and thereby simplifies both the sorting and packing after forming as well as simplifying greatly the construction process on a building site.

The present invention is a development of an invention that is described and claimed in Australian patent application 2004201410 in the name of the applicant. The disclosure in the Australian patent application is incorporated herein by cross-reference.

The Australian patent application describes methods of producing a plurality of roll-formed cladding sheets that have pre-cut or pre-marked ends.

The invention of the Australian patent application includes a method of producing a plurality of roll-formed cladding sheets for building a structure, such as a roof, which includes the steps of:

(a) inputting data relating to a design of the structure, such as a hip, gable or other type of roof of a building, into a computer program that translates the design data into a series of cutting operations of a cutting assembly for cutting strip having a roll-formed profile into a plurality of separate cladding sheets that have the correct size and shape to be placed directly onto an underlying frame and assembled together to form the structure;

(b) roll forming the strip; and

(c) cutting the roll-formed strip with the cutting assembly in accordance with the cutting operations and forming the plurality of separate cladding sheets.

The Australian patent application describes that it is preferred that the above method includes packing the separate cladding sheets in a predetermined order to facilitate subsequent assembling of the sheets to build the structure. By way of particular example, the Australian patent application describes packing the separate cladding sheets in a stack in reverse order so that the top cladding sheet in the stack is the first sheet in the stack that is required for building the structure and each underlying sheet is the next sheet in the stack that is required for building the structure.

In addition, the invention of the Australian patent application includes a method of marking a roll-formed strip to define at least part of the perimeters of a plurality of cladding sheets for building a structure, such as a roof, which includes the steps of:

(a) inputting data relating to a design of the structure, such as a hip, gable or other type of roof of a building, into a computer program that translates the design data into a series of marking operations of a marking assembly for marking at least part of the perimeters of a plurality of cladding sheets onto a roll-formed strip that can be subsequently cut to form separate cladding sheets that have the correct size and shape to be placed directly onto an underlying frame and thereafter assembled together to form the structure;

(b) roll forming the strip; and

(c) marking the roll-formed strip in accordance with the marking operations of the marking assembly and defining at least part of the perimeters of the plurality of cladding sheets that can be subsequently cut to form separate cladding sheets that have the correct size and shape to be placed directly onto an underlying frame and thereafter assembled together to form the structure.

The method described in the preceding paragraph also includes cutting the roll-formed strip on the marked perimeters to form the plurality of separate cladding sheets.

The Australian patent application also describes that there is a wide range of possible options for the above-mentioned computer program and that the form of the computer program may take into account different factors or prioritise the factors differently depending on whether the overall objective of the program is to:

(a) minimise material waste (and therefore optimise the cutting/marking operations to minimise material waste);

(b) maximise production rate (and therefore optimise the time required for the cutting and/or marking operations on the roll-formed strip);

(c) provide the best layout of cladding sheets for the structure (and therefore optimise the cutting/marking operations to optimise the layout of the cladding sheets for the structure); or

(d) a hybrid of two or more of the above options.

The Australian patent application also describes that the factors include, by way of example:

(a) the possible combinations of shapes of cladding sheets that can build a structure of a particular design;

(b) the possible arrangements of the cladding sheet shapes along the length of a roll-formed strip being processed on a roll-former line, and more particularly the interrelationship of different shapes of cladding sheets along the length of the strip being processed on the line;

(c) the roll-form profile and the dimensions of the roll-formed strip being processed on the roll-former line;

(d) the interrelationship of (a), (b), and (c), and the actual design of the structure and the impact of the direction of the prevailing weather on the selection process;

(e) the operating capacity of the roll-forming line;

(f) the operating capacity of the cutting/marking assemblies, and more particularly the capacity of the assemblies to cut/mark different shapes of cladding sheets and (g) transportation and materials handling factors (such as maximum length/width that can be packed and transported).

The Australian patent application also describes that, with regard to factor (d) above, the best possible layout of cladding sheets for a particular structure is influenced by (a) the roll-form profile and the dimensions of the roll-formed strip being processed on the roll-former line, (b) how the design of the cladding sheet “fits” in relation to the features of the structure design, and (c) the prevailing weather direction in relation to the structure and the effect of weather on the cladding sheet.

The applicant has carried out further research and development work in the field of the invention described and claimed in the Australian patent application.

The research and development work has considered a range of issues, such as computer programs that are available for scheduling roll forming of sheets. These programs include the Applicad Roof Wizard program developed by Applicad Australia.

The Applicad Roof Wizard program and other programs known to the applicant schedule roll forming roof cladding sheets on a roll former in an order that aims to reduce wastage. However, the programs do not necessarily schedule roll forming in an order that is easy for a roll former operator or a roofer to deal with the roll formed sheets. Specifically, the programs do not produce roll formed sheets in an order that can be packed in the reverse order required by a roofer. As a consequence, either the roll former operator has to shuffle the sheets at the end of a roll former line into packs, thus slowing and complicating the process and taking up more floor space, or the roll former operator simply packs the sheets in the order produced and the roofer has the time-consuming task of sorting sheets on site. At the moment both the roll former operator and the roofer are dealing with an unnecessary level of complexity.

The present invention is based on the realisation that there is a better way of scheduling the roll forming of roofing sheets than is possible with current programs such as the Applicad Roof Wizard program.

The present invention is also based on the realisation that the invention is not confined to roofing sheets and also extends to walling sheets.

The applicant has developed a set of rules about roll forming that allows a roll former operator to produce and thereafter pack pre-cut or pre-marked roll-formed sheets on a roll former in the order produced by the roll former without shuffling the sheets, thereby simplifying and speeding up the process and actually ending up with sheets in the order that the roofer (or person constructing a wall) might want to use them, thereby speeding up the roofing (or wall construction) process and saving space on site.

The present invention includes applying the rules to a roll forming schedule produced by a current program, such as the Applicad Roof Wizard program, and producing a modified roll forming schedule that roll forms sheets in an order that does not require sorting after roll forming but results in sheets packed in a logical order for the person cladding the structure, such as a roofer.

Generally, the logical order includes placing the starting sheets for each roofing plane on top of the relevant packs.

The present invention also includes a program that incorporates the rules and processes data relating to a design of a structure, such as a roof, and produces a roll forming schedule that roll forms sheets in an order that does not require sorting after roll forming but results in sheets packed in a logical order for the roofer

The rules include the following rules, hereinafter referred to as “the rules”.

1. Looking for pairs of structural planes with similar properties, eg similar pitches and similar numbers and lengths of hips in the case of roof structures.

2. Matching any sheets on these planes that require angle cutting, to minimise wastage.

3. Utilising pairs on planes that have opposing laying directions for this. If only one such plane has a critical laying direction based on viewing direction or prevailing winds, for example, using the opposite laying direction on the other plane in the pair.

4. In the case of roof structures, where a plane runs from hip to valley, it is usually not necessary to pair it up with another plane, as it can be produced and packed with little wastage.

5. In the case of roof structures, where a section of hip roofing runs into another (larger) plane of similar pitch, it is normally possible to merge the smaller hip with the plane that it meets to gain greater efficiences in manufacture.

6. In the case of roof structures, where a gable runs into another roofing plane, the two sides of the gabled roof section can be produced efficiently if they have opposite laying directions. Where a smaller gable section runs into a larger pitched roof to form valleys, it may be possible to merge the valley detail on the smaller gable roof planes with the valley detail on the larger pitched roof for greater efficiencies. Typically this will mean swapping sheets from one side of the gabled roof to the other.

7. All sheets are numbered when produced, normally by branding in some form, and normally on an underlap, to indicate structural plane number and sheets position on the plane.

8. Sheets are ideally packed in the order that they are produced and close to how they will be used on site and to allow individual packs to be located in convenient spots on site.

9. Sequencing minimises the need to sort packs and lay sheets temporarily on bare ground, thus reducing the possibility of damage.

10. Sheets can be produced and packed in an order that minimises damage from cut edges, as most pairs of sheets are similar in overall dimensions to the pairs of sheets above and below.

11. Ends of packs have mainly square cuts, with angle cuts generally contained in the middle of packs for safety.

12. Sheets are sequenced in production and packing such that they are in the logical order in packs that a person cladding a structure wants to use them. In the case of roof cladding, on most planes there are one or two preferred sheets that the roofer will want to start with, then roofing proceeds from those sheets.

13. When sheets are paired up with sheets from another plane, to minimise wastage, it is possible to turn these two sheets end-for-end in roll forming where the profile is not totally symmetrical, depending upon which side of the roll former produces the underlap. This will not affect wastage or practical use on site. For example, if sheet 1 from roofing plane 1 is a perfect match for sheet 7 from plane 2, they can be paired up by producing 1-1 then 2-7, or 2-7 followed by 1-1, this means turning the pair of sheets end for end but simply changes which side of the sheets the underlap is on.

According to the present invention there is provided a method of producing a plurality of roll-formed cladding sheets for building a structure, such as a roof, which includes the steps of:

(a) inputting data relating to a design of the structure into a computer program, such as an Applicad Roof Wizard program, that translates the design data into designs of a plurality of separate cladding sheets that have the correct size and shape to be placed directly onto a support frame and assembled together to complete the cladding of the structure and produces a schedule for roll-forming strip and thereafter cutting roll formed strip into the sheets;

(b) modifying the schedule produced in step (a) in accordance with at least one of the above-described rules,

(c) roll forming the strip, and

(d) cutting the roll formed strip with a cutting assembly in accordance with the modified schedule and forming the plurality of separate cladding sheets.

Preferably step (b) includes modifying the schedule produced in step (a) in accordance with at least one of the rules numbered 1, 2, 3, 7, 8, and 13 in the above-described rules.

According to the present invention there is also provided a method of producing a plurality of roll-formed cladding sheets for building a structure, such as a roof, which includes the steps of:

(a) inputting data relating to a design of the structure into a computer program that includes at least one of the above-described rules and translates the design data into designs of a plurality of separate cladding sheets that have the correct size and shape to be placed directly onto a support frame and assembled together to complete the cladding of the structure and produces a schedule for roll-forming strip and thereafter cutting the roll-formed strip into the sheets;

(b) roll forming the strip, and

(c) cutting the roll-formed strip with a cutting assembly in accordance with the schedule and forming the plurality of separate cladding sheets.

Preferably the computer program includes at least one of the rules numbered 1, 2, 3, 7, 8, and 13 in the above-described rules.

Preferably step (a) of each of the above-described cutting methods includes translating the design data into a series of cutting operations of the cutting assembly.

According to the present invention there is provided a method of marking a roll-formed strip to define at least part of the perimeters of a plurality of cladding sheets for building a structure, such as a roof, which includes the steps of:

(a) inputting data relating to a design of the structure into a computer program, such as an Applicad Roof Wizard program, that translates the design data into designs of a plurality of cladding sheets onto a roll-formed strip that can be subsequently cut to form separate cladding sheets that have the correct size and shape to be placed directly onto a support frame and thereafter assembled together to form the structure and produces a schedule for roll-forming strip and thereafter marking the sheets;

(b) modifying the schedule produced in step (a) in accordance with at least one of the above-described rules,

(c) roll forming the strip, and

(d) marking the roll-formed strip with a marking assembly in accordance with the modified schedule and defining at least part of the perimeters of the plurality of cladding sheets that can be subsequently cut to form separate cladding sheets that have the correct size and shape to be placed directly onto a support frame and thereafter assembled together to complete the cladding of the structure.

Preferably step (b) includes modifying the schedule produced in step (a) in accordance with at least one of the rules numbered 1, 2, 3, 7, 8, and 13 in the above-described rules.

According to the present invention there is also provided a method of marking a roll-formed strip to define at least part of the perimeters of a plurality of cladding sheets for building a structure, such as a roof, which includes the steps of:

(a) inputting data relating to a design of the structure into a computer program that includes at least one of the above-described rules and translates the design data into designs of a plurality of cladding sheets onto a roll-formed strip that can be subsequently cut to form separate cladding sheets that have the correct size and shape to be placed directly onto a support frame and thereafter assembled together to complete the cladding of the structure and produces a schedule for roll-forming strip and thereafter marking the sheets;

(b) roll forming the strip, and

(c) marking the roll-formed strip with a marking assembly in accordance with the schedule and defining at least part of the perimeters of the plurality of cladding sheets that can be subsequently cut to form separate cladding sheets that have the correct size and shape to be placed directly onto a support frame and thereafter assembled together to complete the cladding of the structure.

Preferably the computer program includes at least one of the rules numbered 1, 2, 3, 7, 8, and 13 in the above-described rules.

The marking methods described in the four preceding paragraphs also include cutting the roll-formed strip on the marked perimeters to form the plurality of separate cladding sheets.

Preferably step (a) of each of the above-described marking methods includes translating the design data into a series of marking operations of the marking assembly for marking at least part of the perimeters of the the cladding sheets.

Preferably the above-described cutting and/or marking methods include cutting or marking the roll-formed strip while the strip is being processed on a roll-forming line.

In this situation, preferably the methods include cutting or marking the roll-formed strip transversely to the longitudinal direction of the strip.

Preferably the methods include cutting the roll-formed strip into separate cladding sheets using a cutting assembly that is supported in relation to the roll-forming line to move in response to the programmed cutting operations.

The cutting assembly may be any suitable cutting assembly, such as a shear cutter, a plasma cutter, a laser cutter, or a water-jet cutter.

Preferably the methods include marking the roll-formed strip to define at least part of the perimeters of the smaller separate cladding sheets using a marking assembly that is supported in relation to the roll-forming line to move in response to the programmed marking operations.

The marking assembly may be any suitable marking assembly, including ink jet or laser marking.

Preferably the methods include controlling the operation of the cutting assembly in response to the operation of the roll-forming line.

Preferably the methods include controlling the operation of the marking assembly in response to the operation of the roll-forming line.

Preferably the methods include marking or otherwise branding each cut or marked cladding sheet to identify the sheet so that it can be differentiated by the marked identification from the other cladding sheets that are required to build the structure.

By way of example, the cladding sheets may be marked with consecutive numbers.

By way of further example, the cladding sheets may be marked with a plane number and a laying sequence number for the pack.

Preferably the roll-formed strip is a steel strip.

The roll-formed cladding sheets may be any suitable profile. For example, the cladding sheets may be corrugated sheets having successive crests and the troughs when viewed in transverse section and one underlap side edge and one overlap side edge. The cladding sheets may also include one or more ribs separated by pans and one underlap side edge and one overlap side edge.

Preferably the computer program is capable of generating quotations to supply cladding sheets to build a structure.

According to the present invention there is also provided an apparatus for producing a plurality of cladding sheets for building a structure, which apparatus includes:

(a) a roll-forming line for roll-forming a flat strip, for example wrapped in a coil, into a roll-formed profile;

(b) a cutting assembly for cutting the roll-formed strip into a plurality of separate cladding sheets; and

(c) a control means for controlling the operation of the cutting assembly in response to a computer program that includes at least one of the above-described rules and cutting the roll-formed strip into a plurality of separate cladding sheets, the computer program providing designs of the cladding sheets that have a correct size and shape to be placed directly onto an underlying frame and thereafter assembled together to form the structure.

Preferably the computer program includes at least one of the rules numbered 1, 2, 3, 7, 8, and 13 in the above-described rules.

The cladding sheets may be any suitable profile.

For example, the cladding sheets may be corrugated sheets having successive crests and the troughs when viewed in transverse section and one underlap side edge and one overlap side edge. The cladding sheets may also include one or more ribs separated by pans and one underlap side edge and one overlap side edge.

Preferably the roll-forming line includes an uncoiler for a coil of strip and a series of roll-forming stands for successively roll-forming strip unwound from the uncoiler into a roll-formed profile.

As indicated above, the cutting assembly may be any suitable cutting assembly, such as a shear cutter, a plasma cutter, a laser cutter, or a water-jet cutter.

The cutting assembly may include two or more cutters positioned in relation to the roll-forming line and selectively operable depending on the type of cuts required.

Preferably the cutting assembly includes a cutting head that is able to move in the direction of travel of the roll-formed strip being processed on the roll-forming line and/or transversely to the direction of travel.

Preferably the position of the cutting head is able to be controlled to move normal to the general plane of the roll-formed strip being processed on the roll-forming line to either maintain a constant gap between the strip and the cutting head or to vary that gap in a controlled manner, as required. For example, if using laser or plasma cutting, the distance between the cutting tool and the strip should be reasonably constant throughout the process, whereas when using a shear, the blades may need to move normal to the plane of the strip at the correct time to form the cut.

Preferably where required the cutting head is able to rotate to maintain a constant gap between the roll-formed strip being processed on the roll-forming line and the cutting head. Examples of this include laser or plasma cutting where it is desirable to maintain a constant gap between the cutting tool and any part of the profiled strip.

According to the present invention there is also provided an apparatus for marking a roll-formed cladding sheet to define the perimeters of a plurality of smaller cladding sheets for building a structure, which apparatus includes:

(b) a roll-forming line for roll-forming a flat strip, for example wrapped in a coil, into a roll-formed profile;

(b) a marking assembly for marking the roll-formed strip to define at least part of the perimeters of a plurality of separate cladding sheets that can be subsequently cut from the roll-formed strip that have the correct size and shape to be placed directly onto an underlying frame and thereafter assembled together to form the structure; and

(c) a control means for controlling the operation of the marking assembly in response to a computer program that includes at least one of the above-described rules and providing designs of cladding sheets that have a correct size and shape to be placed directly onto an underlying frame and thereafter assembled together to form the structure.

Preferably the computer program includes at least one of the rules numbered 1, 2, 3, 7, 8, and 13 in the above-described rules.

The roll-formed cladding sheets may be any suitable profile.

For example, the cladding sheets may be corrugated sheets having successive crests and the troughs when viewed in transverse section and one underlap side edge and one overlap side edge.

The cladding sheets may also include one or more ribs separated by pans and one underlap side edge and one overlap side edge.

The applicant has carried out a series of desktop studies of the present invention.

In one particular desktop study, the applicant produced roof cladding sheets for a hip roof of a house that required sheets for five planes. The applicant inputted data relating to the design of the roof into the Applicad Roof Wizard program and the program produced a schedule for roll forming and cutting steel strip into cladding sheets. Thereafter, the applicant manipulated data manually to schedule production of sheets in a different order, in accordance with the above-described rules. Thereafter, the applicant checked that the modified schedule would work using simple processes like cutting up a plan of the roof layout and seeing whether everything can be stacked in packs and unpacked and assembled logically. It was demonstrated that the modified schedule allowed sheets to be produced and packed in the order that the sheets would come off a roll forming line without the need for re-sorting and resulting in sheets able to be packed in a sequence suitable for a roofer to remove and place each sheet from the packs (a) in turn on the roof or (b) in a secondary stack that was subsequently unpacked and placed on the roof in the same order. The modified schedule (ie production sequence), the pack order, and the roofing sequence are set out below.

### 1 Production Sequence:

4-3, 4-7, 4-2, 4-6, 4-4, 4-5, 4-1, 5-1, 2-1, 2-2, 2-4, 2-3, 2-5, 2-6, 2-7, 2-8, 2-9, 2-10, 2-11, 2-12, 2-13, 2-14, 2-15, 2-16, 2-17, 2-18, 3-10, 2-19, 3-9, 2-20, 3-8, 2-21, 3-7, 2-22, 3-6, 2-23, 3-5, 1-22, 3-4, 1-21, 3-3, 1-20, 3-2, 1-19, 3-1, 1-18, 5-2, 1-1, 5-3, 1-2, 5-4, 1-3, 1-4, 1-5, 1-6, 1-7, 1-8, 1-9, 1-10, 1-11, 1-12, 1-13, 1-14, 1-15, 1-16, 1-17

### 2. Packs:

| | | | | | | | |
|---|---|---|---|---|---|---|---|
| A | B | C | D | E | F | G | H |

| | | | | |
|---|---|---|---|---|
| 1-17 | 1-3 | 2-23 | 2-18 | 5-1 |
| | 5-4 | 3-6 | | |
| 1-16 | 1-2 | 2-22 | 2-17 | 4-1 |
| | 5-3 | 3-7 | | 4-5 |
| 1-15 | 1-1 | 2-21 | 2-16 | 4-4 |
| | 5-2 | 3-8 | | |
| 1-14 | 1-18 | 2-20 | 2-15 | 4-6 |
| | 3-1 | 3-9 | | 4-2 |
| 1-13 | 1-19 | 2-19 | 2-14 | 4-7 |
| | 3-2 | 3-10 | | 4-3 |
| 1-12 | 1-20 | | 2-13 | |
| | 3-3 | | | |
| 1-11 | 1-21 | | 2-12 | |
| | 3-4 | | | |
| 1-10 | 1-22 | | 2-11 | |
| | 3-5 | | | |
| 1-9 | | | 2-10 | |
| 1-8 | | | 2-9 | |
| 1-7 | | | 2-8 | |
| 1-6 | | | 2-7 | |
| 1-5 | | | 2-6 | |
| 1-4 | | | 2-5 | |
| | | | 2-3 | |
| | | | 2-4 | |
| | | | 2-2 | |
| | | | 2-1 | |

### 3. Roofing Sequence :

Open Pack A

1-17 (critical sheet), 1-16, 1-15, 1-14, 1-13, 1-12, 1-11, 1-10, 1-9, 1-8, 1-7, 1-6, 1-5, 1-4

Finish Pack A, but keep for sheets put aside

Open Pack B

Use 1-3, put 5-4 on empty Pack A

Use 1-2, put 5-3 on top of 5-4

Use 1-1, put 5-2 on top of 5-3

Use 1-18, put 3-1 on top of 5-2

Use 1-19, put 3-2 on top of 3-1

Use 1-20, put 3-3 on top of 3-2

Use 1-21, put 3-4 on top of 3-3

Use 1-22, put 3-5 on top of 3-4

First roofing plane finished, Pack B empty

Use some of sheets put aside

3-5 (critical sheet), 3-4, 3-3, 3-2, 3-1

Open Pack C

Use 3-6, put 2-23 aside, on top of 5-2

Use 3-7, put 2-22 on top of 2-23

Use 3-8, put 2-21 on top of 2-22

Use 3-9, put 2-20 on top of 2-21

Use 3-10, put 2-19 on top of 2-20

Second roofing plane finished, Pack C empty

Open Pack D

2-18 (critical sheet), 2-17, 2-16, 2-15, 2-14, 2-13, 2-12, 2-11, 2-10, 2-9, 2-8, 2-7, 2-6, 2-5, 2-4, 2-3, 2-2, 2-1

Pack D empty

Use some of sheets put aside

2-19, 2-20, 2-21, 2-22, 2-23

Third roofing plane finished

5-2, 5-3, 5-4

No sheets left aside

Open Pack E

5-1

Use 4-5 (critical sheet), put 4-1 aside

Use 4-4

Use 4-6, put 4-2 on top of 4-1

4-7, 4-3, 4-2, 4-1

### Roof Complete

The present invention is described further by way of example with reference to the accompanying drawing which is a diagram that illustrates one embodiment of an apparatus for producing a plurality of cladding sheets in accordance with the invention.

The apparatus shown in the Figure comprises a standard roll-forming line that has been modified to include marking and/or cutting assemblies for marking and/or cutting a roll-formed cladding sheet.

With reference to the Figure, flat steel strip is unwound from a coil 5 and passed successively through a series of roll-formers 7 that progressively roll a required profile in the strip. By way of example, the profile may comprise a series of lengthwise extending flat pans separated by upstanding ribs with side edge formations to allow adjacent subsequently formed cladding sheets to be positioned in side by side overlapping relationship.

The roll-formed strip emerging from the last of the roll-formers is moved past a position sensor 17 for sensing the position of the strip, a marking assembly 9, a first cutting assembly 11, and a second cutting assembly 13 in the form of an exit shear. These assemblies 9, 11, 13 are selectively operable to mark and/or cut the roll-formed strip to produce cladding sheets having required shapes.

The cladding sheets emerging from the end shear 13 are passed to a sheet handling station 15 and are stacked or otherwise handled as required.

The marking assembly 9 is operable to mark the roll-formed strip to define the ends of non-squared cladding sheets. The marked roll-formed strip is subsequently square cut, typically by the end shear 13, outboard of the marked ends of the strip. The marked ends of the cladding sheets can be subsequently cut, for example at a building site, to form cladding sheets with the required shape.

The marking assembly 9 is also operable to brand the roll-formed strip to uniquely identify each subsequently cut cladding sheet.

The above-described apparatus is controlled by a computer program that includes the above-described rules and that:

(a) translates design data for a structure, such as a roof of a house, into a series of marking and/or cutting operations of the marking and/or cutting assemblies 9, 11, 13 for marking and/or cutting roll-formed strip to form the cladding sheets; and

(b) in part controls the roll-forming line;

(c) in part controls the marking and/or cutting assemblies 9, 11, 13 and marks and/or cuts the roll-formed strip to form cladding sheets having the required shapes.

The operation of the marking and/or cutting assemblies 9, 11, 13 is responsive to the requirements of the programmed series of marking and/or cutting operations and the actual operation of the roll forming line at any given point in time, as monitored by the sensor 17.

Depending on the type of end profile required for a cladding sheet, one or both of the cutting assemblies 11, 13 may be operated. For example, in a number of situations it may only be necessary to square cut the ends of the roll-formed strip. In these situations operation of the exit shear 13 may only be required. In other situations it may be necessary to form angled straight cuts on the ends of the roll-formed strip. In these situations operation of the cutting assembly 11 may be appropriate. In particular, the cutting assembly 11 may be a shear cutter that is operable to move along the length of the roll-former line with the roll-formed strip and form the angled cut during the course of such movement. In other situations it may be necessary to form more complex cuts on the ends of the roll-formed strip. In such situations, operation of both cutting assemblies 11, 13 may be appropriate to complete the cuts.

Many modifications may be made to the preferred embodiment of the present invention described above without departing from the spirit and scope of the present invention.

1. A method of producing a plurality of roll-formed cladding sheets for building a structure, such as a roof, which includes the steps of:
(a) inputting data relating to a design of the structure into a computer program, such as an Applicad Roof Wizard program, that translates the design data into designs of a plurality of separate cladding sheets that have the correct size and shape to be placed directly onto a support frame and assembled together to complete the cladding of the structure and produces a schedule for roll-forming strip and thereafter cutting roll formed strip into the sheets;
(b) modifying the schedule produced in step (a) in accordance with at least one of the rules, as described herein,
(c) roll forming the strip, and
(d) cutting the roll formed strip with a cutting assembly in accordance with the modified schedule and forming the plurality of separate cladding sheets.

2. The method defined in claim 1 wherein step (b) includes modifying the schedule produced in step (a) in accordance with at least one of the rules numbered 1, 2, 3, 7, 8, and 13 in the above-described rules.

3. A method of producing a plurality of roll-formed cladding sheets for building a structure, such as a roof, which includes the steps of:
(a) inputting data relating to a design of the structure into a computer program that includes at least one of the rules, as described herein, and translates the design data into designs of a plurality of separate cladding sheets that have the correct size and shape to be placed directly onto a support frame and assembled together to complete the cladding of the structure and produces a schedule for roll-forming strip and thereafter cutting roll formed strip into the sheets;
(b) roll forming the strip, and
(c) cutting the roll-formed strip with a cutting assembly in accordance with the schedule and forming the plurality of separate cladding sheets.

4. The method defined in claim 3 wherein the computer program includes at least one of the rules numbered 1, 2, 3, 7, 8, and 13 in the above-described rules.

5. The method defined in claim 3 wherein step (a) includes translating the design data into a series of cutting operations of the cutting assembly.

6. The method defined in claim 3 includes cutting the roll-formed strip while the strip is being processed on a roll-forming line.

7. The method defined in claim 6 includes cutting the roll-formed strip transversely to the longitudinal direction of the strip.

8. The method defined in claim 6 includes cutting the roll-formed strip into separate cladding sheets using a cutting assembly that is supported in relation to the roll-forming line to move in response to the programmed cutting operations.

9. The method defined in claim 6 includes controlling the operation of the cutting assembly in response to the operation of the roll-forming line.

10. The method defined in claim 3 includes marking or otherwise branding each cut cladding sheet with consecutive numbers.

11. The method defined in claim 9 includes marking or otherwise branding each cut or marked cladding sheet with a plane number and a laying sequence number for the pack.

12. A method of marking a roll-formed strip to define at least part of the perimeters of a plurality of cladding sheets for building a structure, such as a roof, which includes the steps of:
(a) inputting data relating to a design of the structure into a computer program, such as an Applicad Roof Wizard program, that translates the design data into designs of a plurality of cladding sheets onto a roll-formed strip that can be subsequently cut to form separate cladding sheets that have the correct size and shape to be placed directly onto a support frame and thereafter assembled together to form the structure and produces a schedule for roll-forming strip and thereafter marking the sheets;
(b) modifying the schedule produced in step (a) in accordance with at least one of the rules, as described herein,
(c) roll forming the strip, and
(d) marking the roll-formed strip with a marking assembly in accordance with the schedule and defining at least part of the perimeters of the plurality of cladding sheets that can be subsequently cut to form separate cladding sheets that have the correct size and shape to be placed directly onto a support frame and thereafter assembled together to complete the cladding of the structure.

13. The method defined in claim 12 wherein step (b) includes modifying the schedule produced in step (a) in accordance with at least one of the rules numbered 1, 2, 3, 7, 8, and 13 in the above-described rules.

14. A method of marking a roll-formed strip to define at least part of the perimeters of a plurality of cladding sheets for building a structure, such as a roof, which includes the steps of:
(a) inputting data relating to a design of the structure into a computer program that includes at least one of the rules, as described herein, and translates the design data into designs of a plurality of cladding sheets onto a roll-formed strip that can be subsequently cut to form separate cladding sheets that have the correct size and shape to be placed directly onto a support frame and thereafter assembled together to complete the cladding of the structure and produces a schedule for roll-forming strip and thereafter marking the sheets;
(b) roll forming the strip, and
(c) marking the roll-formed strip with a marking assembly in accordance with the schedule and defining at least part of the perimeters of the plurality of cladding sheets that can be subsequently cut to form separate cladding sheets that have the correct size and shape to be placed directly onto a support frame and thereafter assembled together to complete the cladding of the structure.

15. The method defined in claim 14 wherein the computer program includes at least one of the rules numbered 1, 2, 3, 7, 8, and 13 in the above-described rules.

16. The method defined in claim 14 wherein step (a) includes translating the design data into a series of marking operations of the marking assembly for marking at least part of the perimeters of the cladding sheets.

17. The method defined in claim 14 also includes cutting the roll-formed strip on the marked perimeters to form the plurality of separate cladding sheets.

18. The method defined in claim 14 includes marking the roll-formed strip while the strip is being processed on a roll-forming line.

19. The method defined in claim 18 includes marking the roll-formed strip transversely to the longitudinal direction of the strip.

20. The method defined in claim 18 includes cutting the roll-formed strip into separate cladding sheets using a cutting assembly that is supported in relation to the roll-forming line to move in response to the programmed cutting operations.

21. The method defined in claim 18 includes marking the roll-formed strip to define at least part of the perimeters of the smaller separate cladding sheets using a marking assembly that is supported in relation to the roll-forming line to move in response to the programmed marking operations.

22. The method defined in claim 18 includes controlling the operation of the marking assembly in response to the operation of the roll-forming line.

23. The method defined in claim 14 includes marking or otherwise branding each marked cladding sheet to identify the sheet so that it can be differentiated by the marked identification from the other cladding sheets that are required to build the structure.

24. The method defined in claim 14 includes marking or otherwise branding each marked cladding sheet with consecutive numbers.

25. The method defined in claim 12 or claim 14 includes marking or otherwise branding each marked cladding sheet with a plane number and a laying sequence number for the pack.

26. An apparatus for producing a plurality of cladding sheets for building a structure, which apparatus includes:
(a) a roll-forming line for roll-forming a flat strip, for example wrapped in a coil, into a roll-formed profile;
(b) a cutting assembly for cutting the roll-formed strip into a plurality of separate cladding sheets; and
(c) a controller for controlling the operation of the cutting assembly in response to a computer program that includes at least one of the above-described rules and cutting the roll-formed strip into a plurality of separate cladding sheets, the computer program providing designs of separate cladding that have a correct size and shape to be placed directly onto an underlying frame and thereafter assembled together to form the structure.

27. The apparatus defined in claim 26 wherein the computer program includes at least one of the rules numbered 1, 2, 3, 7, 8, and 13 in the above-described rules.

28. The apparatus defined in claim 26 wherein the cladding sheets are corrugated sheets having successive crests and the troughs when viewed in transverse section and one underlap side edge and one overlap side edge.

29. The apparatus defined in claim 28 wherein the cladding sheets include one or more ribs separated by pans and one underlap side edge and one overlap side edge.

30. The apparatus defined in claim 26 wherein the roll-forming line includes an uncoiler for a coil of strip and a series of roll-forming stands for successively roll-forming strip unwound from the uncoiler into a roll-formed profile.

31. The apparatus defined in claim 26 wherein the cutting assembly is selected from the group that includes a shear cutter, a plasma cutter, and a laser cutter.

32. The apparatus defined in claim 26 wherein the cutting assembly includes two or more cutters positioned in relation to the roll-forming line and selectively operable depending on the type of cuts required.

33. The apparatus defined in claim 26 wherein the cutting assembly includes a cutting head that is able to move in the direction of travel of the roll-formed strip being processed on the roll-forming line and/or transversely to the direction of travel.

34. The apparatus defined in claim 33 wherein the position of the cutting head is able to be controlled to move normal to the general plane of the roll-formed strip being processed on the roll-forming line to either maintain a constant gap between the strip and the cutting head or to vary that gap in a controlled manner, as required.

35. The apparatus defined in claim 34 wherein the cutting head is able to rotate to maintain a constant gap between the roll-formed strip being processed on the roll-forming line and the cutting head.

36. An apparatus for marking a roll-formed cladding sheet to define the perimeters of a plurality of smaller cladding sheets for building a structure, which apparatus includes:
(a) a roll-forming line for roll-forming a flat strip, for example wrapped in a coil, into a roll-formed profile;
(b) a marking assembly for marking the roll-formed strip to define at least part of the perimeters of a plurality of separate cladding sheets that can be subsequently cut from the roll-formed strip that have the correct size and shape to be placed directly onto an underlying frame and thereafter assembled together to form the structure; and
(c) a controller for controlling the operation of the marking assembly in response to a computer program that includes at least one of the above-described rules and providing designs of cladding sheets that have a correct size and shape to be placed directly onto an underlying frame and thereafter assembled together to form the structure.

37. The apparatus defined in claim 36 wherein the computer program includes at least one of the rules numbered 1, 2, 3, 7, 8, and 13 in the above-described rules.

38. The apparatus defined in claim 36 wherein the cladding sheets are corrugated sheets having successive crests and the troughs when viewed in transverse section and one underlap side edge and one overlap side edge.

39. The apparatus defined in claim 38 wherein the cladding sheets include one or more ribs separated by pans and one underlap side edge and one overlap side edge.
